(19) United States
(12) Patent Application Publication
(10) Pub. No.: US 2007/0144323 A1
(43) Pub. Date: Jun. 28, 2007

(54) Drum sectioner

(75) Inventor: Philip King, Bonner Springs, KS (US)

Correspondence Address: REHRIG PACIFIC, 4010 E. 26TH STREET, LOS ANGELES, CA, 90023, US

(73) Assignee: Rehrig Pacific Company

(21) Appl. No.: 11/317,551

(22) Filed: Dec. 22, 2005

(51) Int. Cl. B26D 1/00

(52) U.S. Cl. 83/651

(57) ABSTRACT

A drum sectioner includes a plurality of wires extending between an upper chamber and a lower chamber. Electrical current through the wires causes the wires to become hot enough to melt/cut plastic. One ore more plastic drums placed in the upper chamber are sectioned by the hot wires without producing any shavings or dust. The drum is sectioned as it descends from the upper chamber to the lower chamber through the wires.

### BACKGROUND OF THE INVENTION

The present invention relates generally to a drum sectioner.

Plastic drums are sometimes used for shipping liquids. Some plastic drums that are used to ship beverages are not reused, but are shipped back empty to the supplier. The supplier grinds the plastic drum and recycles the plastic. The empty drums are somewhat burdensome to return, because of the volume that they occupy.

A known machine uses a combination of band saws and rotating cutters to cut the plastic drums before returning them to the supplier. One band saw cuts the drum longitudinally (along the axis of symmetry of the drum) and two other band saws cut the top and bottom off the drum. This greatly reduces the volume occupied by the empty drum and the cost and effort in shipping it back to the supplier. However, the band saws generate plastic shavings and dust, which is undesirable.

### SUMMARY OF THE INVENTION

The present invention provides a drum sectioner which cuts an empty plastic drum into a plurality of pieces for return to the supplier, without any shavings or dust. The drum sectioner includes a plurality of hot wires that cut the empty plastic drum cleanly in up to six pieces, depending on the size.

In a preferred embodiment, the drum sectioner includes a longitudinal wire aligned with the axis of symmetry of the drum and a pair of lateral wires positioned adjacent the top and bottom of the drum. The wires separate an upper chamber from a lower chamber in a sealed housing. One or more whole, empty drums are placed in the upper chamber on top of the wires. As electrical current is passed through the wires, the wires heat and begin to melt the drum. The hot wires cut through the drum as the drum begins to descend (e.g. by force of gravity) from the upper chamber to the lower chamber. The drum is sectioned into smaller pieces that are received in the lower chamber, without dust or shavings. The pieces can easily be shipped back to the supplier or to a recycler.

### BRIEF DESCRIPTION OF THE DRAWINGS

Other advantages of the present invention can be understood by reference to the following detailed description when considered in connection with the accompanying drawings wherein:

FIG. 1 is a perspective view of a drum sectioner according to a first embodiment of the present invention with an empty drum being inserted.

FIG. 2 is the drum sectioner of FIG. 1, with the drum in position for the cutting process to begin.

FIG. 3 is a sectional view taken along line 3-3 of FIG. 2.

FIG. 4 is a sectional view taken along line 4-4 of FIG. 3.

FIG. 5 is a sectional view taken along line 5-5 of FIG. 3.

FIG. 6 is a perspective view of a drum sectioner according to a second embodiment of the present invention.

FIG. 7 is a schematic top view of the wires inside the drum sectioner of FIG. 6.

### DETAILED DESCRIPTION OF THE PREFERRED EMBODIMENT

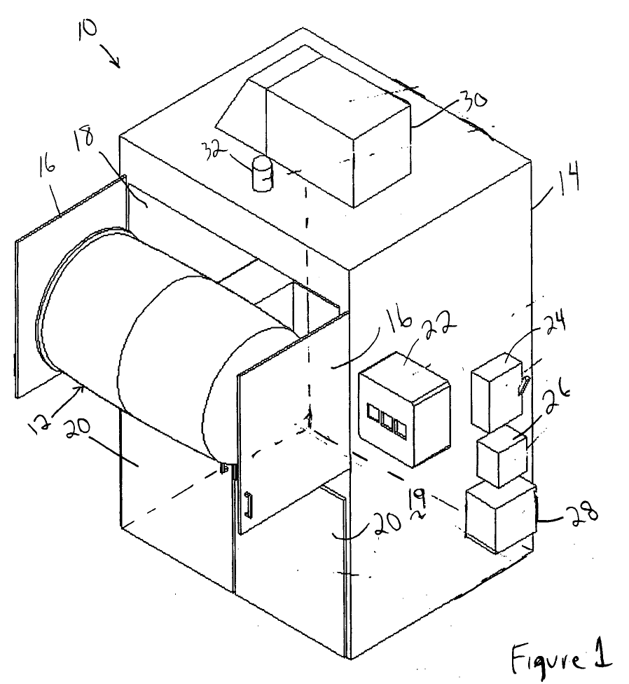

A drum sectioner 10 for sectioning empty plastic drums 12 according to the present invention is shown in FIG. 1. The drum sectioner 10 includes a cabinet or housing 14 having upper doors 16 leading to an upper chamber 18 and lower doors 20 leading to a lower chamber 19.

A controller 22, such as a CPU, FPGA, or hard-wired circuitry controls the drum sectioner 10 to perform the functions described herein. The controller 22 controls power supplied through a fused disconnect 24 and by transformers 26, 28. The controller 22 also controls a fume cleaner 30 for removing any fumes generated in the drum sectioning process. An indicator light 32 indicates the status of the drum sectioning process.

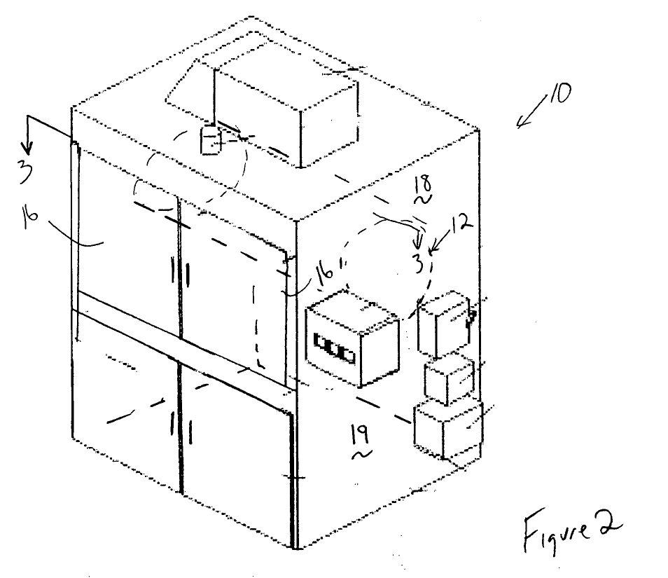

FIG. 2 shows the drum sectioner 10 after the drum 12 has been inserted into the upper chamber 18 and the upper doors 16 have been closed. When the drum 12 is inserted and the upper doors 16 and lower doors 20 have been latched, the controller 22 turns on the power supplies, including the transformers 26, 28.

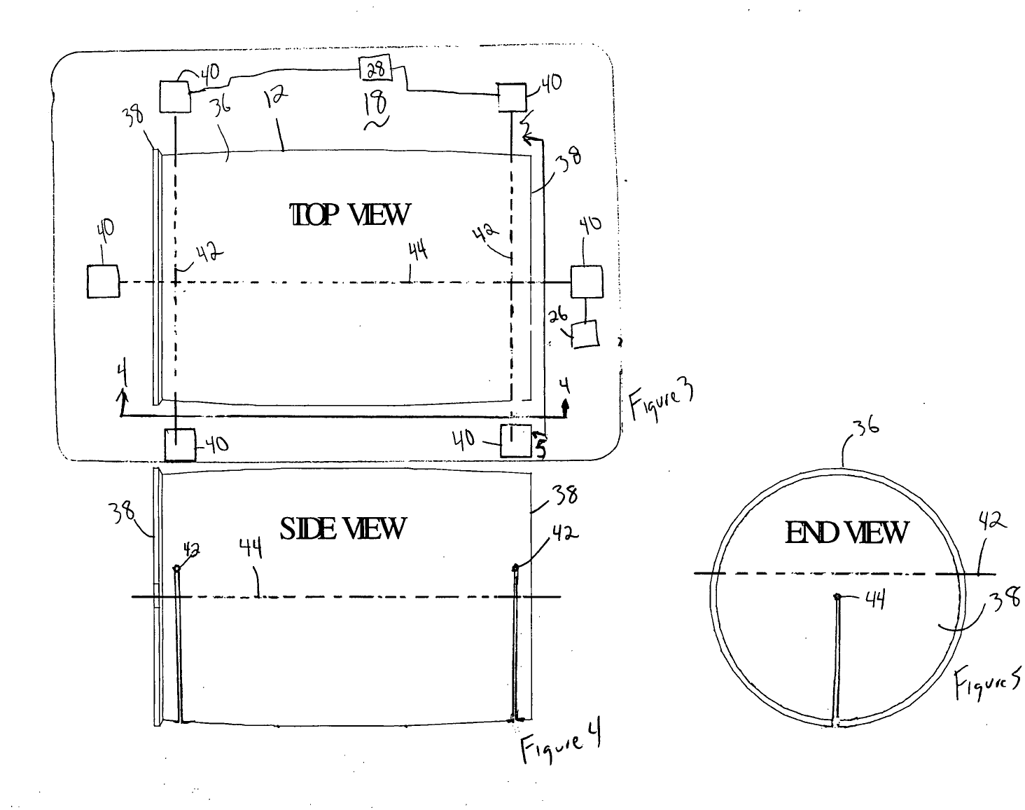

Referring to FIG. 3, the transformers 26, 28 supply power to electrical connectors 40 that send electrical current through a longitudinal wire 42 and a pair of lateral wires 44. The longitudinal wire 42 is generally aligned with the axis of symmetry of the drum 12. The lateral wires 44 are aligned against a side wall 36 of the drum 12 and adjacent the upper and lower end walls 38 of the drum 12. The longitudinal wire 42 and lateral wires 44 are positioned between the upper chamber 18 and the lower chamber 19 (FIG. 2). The drum 12 rests on the wires 42, 44 when the drum is in the upper chamber 18.

When current is supplied to the wires 42, 44, the wires 42, 44 achieve a high enough temperature to melt the plastic of the drum 12. The weight of the drum 12 pushes the drum 12 through the wires 42, 44, thereby cutting the drum 12 into sections.

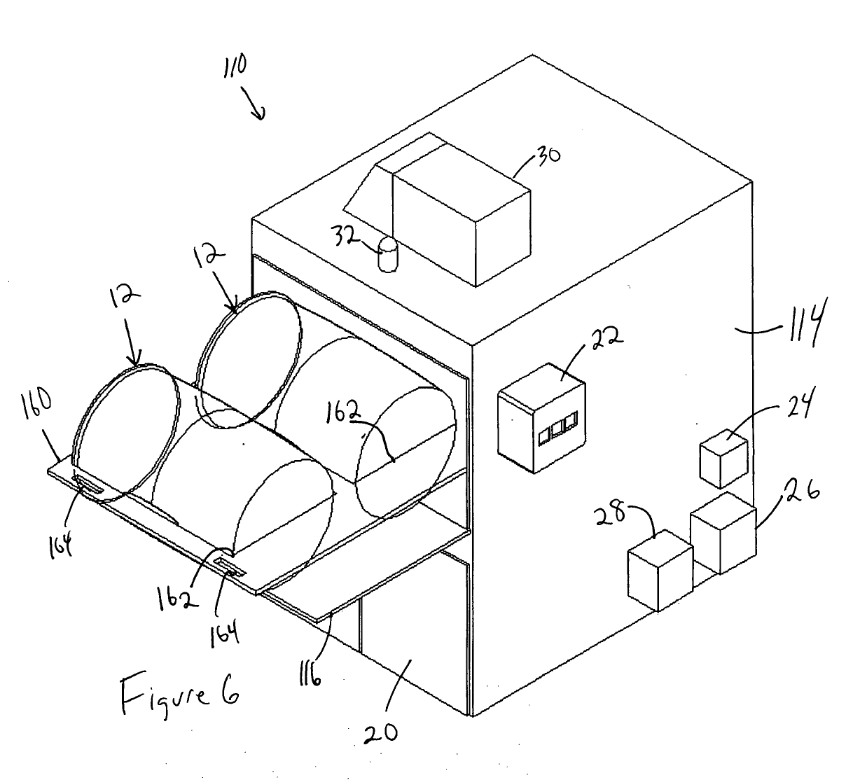

As shown in FIG. 4, with the cutting of the drum 12 in process, the lateral wires 44 are cutting through the side wall 36 of the drum 12 to separate the upper and lower ends 38 of the drum 12. Referring to FIG. 5, the longitudinal wire 44 cuts the side wall 36 into two pieces and cuts each of the upper and lower ends 38 into two. The weight of the drum 12 forces the drum 12 slowly through the hot wires 42, 44. Alternatively, the wires 42, 44 could move relative to the housing 14 or a device could push the drum 12 through the wires 42, 44.

When the drum 12 passes completely through the wires 42, 44, the six pieces of the drum 12 drop into the lower chamber 19 of the drum sectioner 10 and can be removed through the lower doors 20 (FIG. 2). Several drums 12 can be sectioned before emptying the lower chamber 19.

The hot wires 42, 44 cut the drum 12 into manageable pieces that can be shipped in less volume without producing plastic shavings or dust. The drum sectioner 12 is automated and requires very little effort by the user.

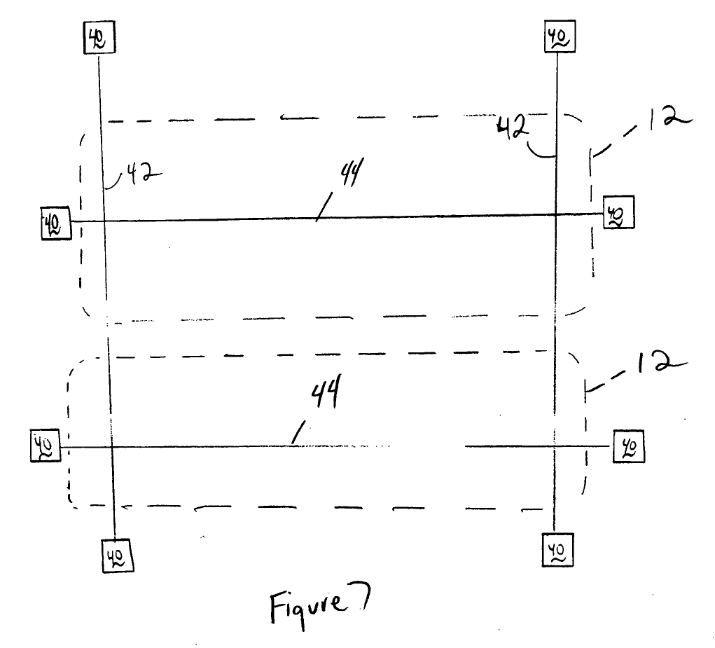

A drum sectioner 110 according to a second embodiment is shown in FIG. 6. Elements of the drum sectioner 110 that are similar to those in the drum sectioner 10 of FIGS. 1-5 are given identical reference numbers. The drum sectioner 110 is designed to section two drums 12 at once. Other drum sectioners that can section more than two at once could also be used and would be within the scope of the present invention. The drum sectioner 110 includes a larger housing 114 and an upper door 116 that pivots down. A template 160 slides in and out of the housing 114 through the open upper door 116. The template 160 includes a plurality of openings 162 into which are received empty drums 12 (which are supported on the open upper door 116. The template 160 may include handles 164 for facilitating sliding the template 160 and drums 12 in and out of the housing 114. When the template 160 is pushed into the housing 114, the drums 12 are each aligned with and supported on wires 42, 44 (FIG. 7) as was the single drum 12 in the first embodiment.

FIG. 7 is a schematic top view of the wires 42, 44 inside the drum sectioner 110 of FIG. 6. The drums 12 are shown in phantom to illustrate their alignment with the lateral wires 42 and the longitudinal wires 44 during operation. After the drums 12 are aligned with the wires 42, 44, the wires are heated and the drums 12 are each sectioned as described above with respect to the first embodiment.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention. For example, the arrangement and number of wires 42, 44 could be changed.

What is claimed is:

1. A drum sectioner comprising:
at least one longitudinal wire;
a first lateral wire;
a second lateral wire; and
at least one power supply supplying electrical current through the at least one longitudinal wire, the first lateral wire and the second lateral wire.

2. The drum sectioner of claim 1 wherein the at least one power supply includes a first power supply supplying current to the first lateral wire, a second power supply supplying current to the second lateral wire and a third power supply supplying current to the longitudinal wire.

3. The drum sectioner of claim 1 wherein the first lateral wire and the second lateral wire are generally perpendicular to the longitudinal wire.

4. The drum sectioner of claim 1 wherein the longitudinal wire, first lateral wire and second lateral wire become hot upon the application of the electrical current.

5. The drum sectioner of claim 1 further including a drum receiving compartment for receiving a whole drum, the drum receiving compartment positioned above the longitudinal wire, the first lateral wire and the second lateral wire.

6. A method for cutting a drum including the steps of:
a) heating a plurality of wires by passing electrical current through the plurality of wires; and
b) moving the plurality of wires through the drum.

7. The method of claim 6 wherein said step b) is performed solely by gravity pulling downward on the drum.

8. The method of claim 6 wherein the plurality of wires includes a longitudinal wire generally parallel to an axis of the drum and at least one lateral wire.

9. The method of claim 6 wherein the at least one lateral wire includes a pair of lateral wires, each adjacent an axial end of the drum.

10. A drum sectioner comprising:
a housing into which drum can be inserted;
at least one longitudinal wire extending through an interior compartment of the housing;
a plurality of wires extending through an interior compartment of the housing and at least one power supply supplying electrical current through the plurality of wires.

11. The drum sectioner of claim 10 wherein the housing includes an upper chamber and a lower chamber.

12. The drum sectioner of claim 11 wherein the plurality of wires are disposed between the upper chamber and the lower chamber.

13. The drum sectioner of claim 10 wherein two of the plurality of wires are generally perpendicular one another.

14. The drum sectioner of claim 10 wherein the plurality of wires become hot upon the application of the electrical current.
